(19) United States
(12) Patent Application Publication
(10) Pub. No.: US 2014/0192169 A1
(43) Pub. Date: Jul. 10, 2014

(54) STEREOSCOPIC IMAGE DISPLAY DEVICE, CONTROL DEVICE, AND DISPLAY PROCESSING METHOD

(71) Applicant: KABUSHIKI KAISHA TOSHIBA, Tokyo (JP)

(72) Inventors: Masako KASHIWAGI, Yokohama-shi (JP); Ayako Takagi, Yokosuka-shi (JP); Shinichi Uehara, Tokyo (JP); Masahiro Baba, Yokohama-shi (JP)

(21) Appl. No.: 14/204,262

(22) Filed: Mar. 11, 2014

Related U.S. Application Data
(63) Continuation of application No. PCT/JP2011/071141, filed on Sep. 15, 2011.

(51) Int. Cl. G02B 27/22; H04N 13/04

(52) U.S. Cl. CPC G02B 27/2214; H04N 13/0402
USPC 348/51

(57) ABSTRACT

According to an embodiment, a stereoscopic image display device includes a display, an optical element, a detector, a calculator, a deriver, and an applier. The display has a display surface including pixels arranged thereon. The optical element has a refractive-index distribution that changes according to an applied voltage. The detector detects a viewpoint position representing a position of a viewer. The calculator calculates a gravity point of the viewpoint positions when a plurality of viewpoint positions are detected. The deriver derives a drive mode according to the gravity point, where the drive mode is indicative of a voltage to be applied to the optical element. The applier applies a voltage to the optical element according to the drive mode such that a visible area within which a display object displayed on the display is stereoscopically viewable is set at the gravity position.

### CROSS-REFERENCE TO RELATED APPLICATION

This application is a continuation of International Application No. PCT/JP2011/071141, filed on Sep. 15, 2011, the entire contents of which are incorporated herein by reference.

### FIELD

Embodiments described herein relate generally to a stereoscopic image display device, a control device, and a display processing method.

### BACKGROUND

There are stereoscopic image display devices which enable viewers to view stereoscopic images with the unaided eye and without having to use special glasses. In such a stereoscopic image display device, a plurality of images having mutually different viewpoints is displayed, and an optical element is used to control the light beams. Then, the controlled light beams are guided to both eyes of a viewer. If the viewer is present at an appropriate position, he or she becomes able to view stereoscopic images. As far as the light beam element is concerned, a parallax barrier or a lenticular known are known.

However, in the method in which a parallax barrier or a lenticular lens is used as the optical element, the resolution of stereoscopic images undergoes a decline or the display quality of planar (2D) images deteriorates. In that regard, a technology is known in which a liquid crystal optical element or a birefringent element is used as the optical element.

For example, in Japan Patent Application Laid-open No. 2008-233469, a configuration is disclosed in which a substrate, a birefringent material, and a lens array are mounted in that particular order on a planar display device such as a liquid crystal display. Moreover, in Japan Patent Application Laid-open No. 2008-233469, the direction of the maximum principle axis of the birefringent material, which is the long axis direction of the birefringent material, is tilted in the direction opposite to the viewer and is parallel to the ridgeline of the lens. Meanwhile, in Japan Patent Application Laid-open No. 2009-520232, a technology is disclosed in which the position of the principal point of a liquid crystal lens is temporally varied by performing voltage control.

However, in the conventional technology, if a change occurs in the viewpoint position that represents the position of a viewer who is viewing display images, then the condition becomes prone to an increase in the amount of crosstalk.

### BRIEF DESCRIPTION OF THE DRAWINGS

FIG. 1 is a block diagram illustrating a stereoscopic image display device according to an embodiment;

FIG. 2 is a schematic diagram illustrating a display unit according to the embodiment;

FIG. 3 is a schematic diagram illustrating an optical element according to the embodiment;

FIG. 4 is a diagram illustrating an example of the changes in the refractive index of the optical element and the orientation state of a liquid crystal according to the embodiment;

FIGS. 5A and 5B illustrate a flowchart for explaining a display process performed according to the embodiment;

FIGS. 6 and 7 are schematic diagrams each illustrating an example of a plurality of viewpoint positions and a setup visible area according to the embodiment;

FIG. 8 is a flowchart for explaining a refractive-index distribution derivation process performed according to the embodiment; and

FIG. 9 is a schematic diagram illustrating the positional relationship between a reference point and the display unit according to the embodiment.

### DETAILED DESCRIPTION

According to an embodiment, a stereoscopic image display device includes a display, an optical element, a detector, a calculator, a deriver, and an applier. The display has a display surface including pixels arranged thereon. The optical element has a refractive-index distribution that changes according to an applied voltage. The detector is configured to detect a viewpoint position representing a position of a viewer. The calculator is configured to calculate a gravity point of the viewpoint positions when a plurality of viewpoint positions are detected. The deriver is configured to derive a drive mode according to the gravity point, where the drive mode is indicative of a voltage to be applied to the optical element. The applier is configured to apply a voltage to the optical element according to the drive mode such that a visible area within which a display object displayed on the display is stereoscopically viewable is set at the gravity position.

An exemplary embodiment of a stereoscopic image display device, a stereoscopic image display method (a display processing), and a computer program product according to the invention is described below in details with reference to the accompanying drawings.

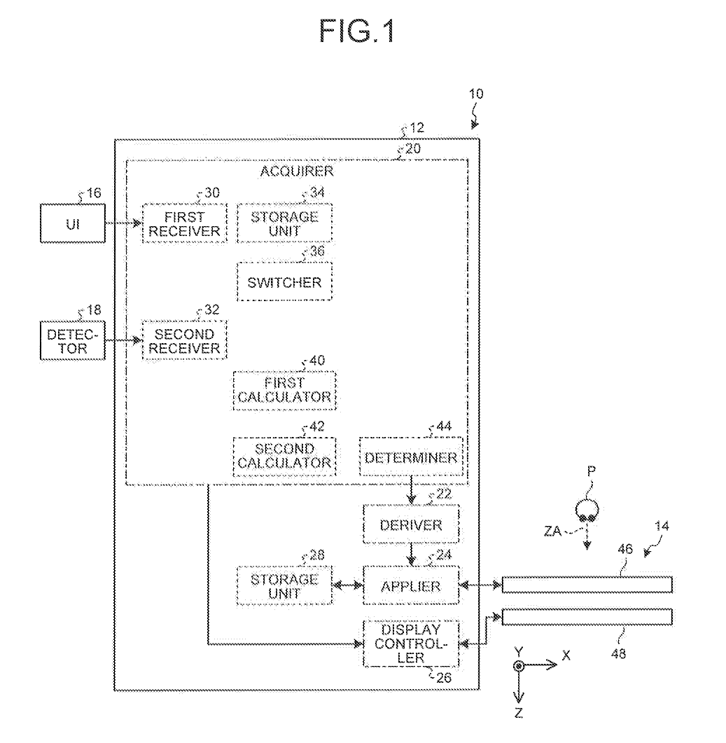

FIG. 1 is a block diagram illustrating a functional configuration of a stereoscopic image display device 10. Herein, the stereoscopic image display device 10 is capable of displaying stereoscopic images. Besides, the stereoscopic image display device 10 is also capable of displaying planar images. That is, the stereoscopic image display device 10 is not limited to displaying stereoscopic images.

The stereoscopic image display device 10 includes a user interface (UI) unit 16, a detector 18, a display unit 14, and a controller 12.

The display unit 14 is a display device for displaying stereoscopic images or planar images.

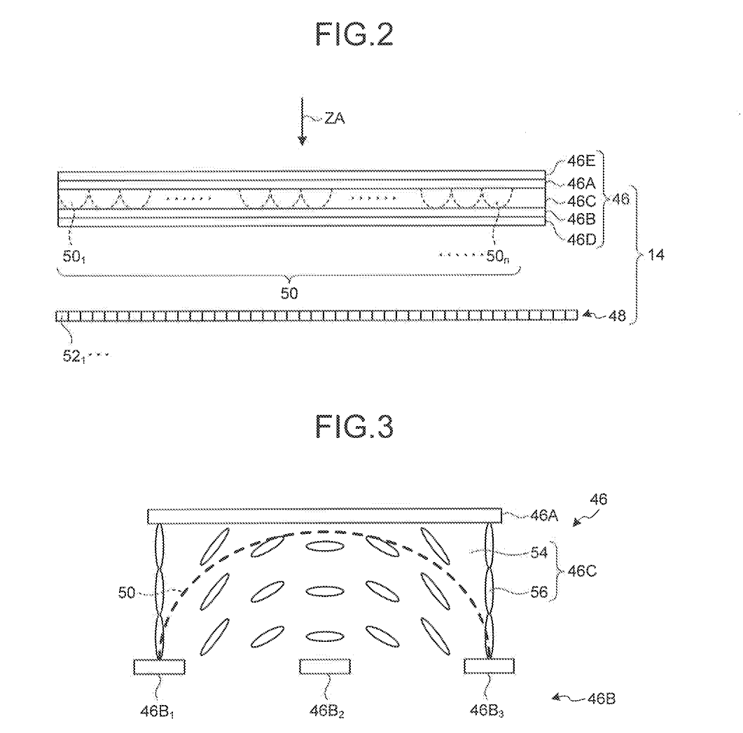

FIG. 2 is a schematic diagram illustrating an overall configuration of the display unit 14. As illustrated in FIG. 2, the display unit 14 includes an optical element 46 and a display 48. When a viewer P views the display 48 via the optical element 46 (in FIGS. 1 and 2, see the direction of an arrow ZA), he or she becomes able to view the stereoscopic images displayed on the display unit 14.

The display 48 displays thereon, for example, parallax images that are used in displaying a stereoscopic image. The display 48 has a display surface in which a plurality of pixels 52 is arranged in a matrix-like manner in a first direction and a second direction. Herein, the first direction is, for example, the row direction (the X-axis direction (the horizontal direction) with reference to FIG. 1), and the second direction is, for example, the column direction (the Y-axis direction (the vertical direction) with reference to FIG. 1).

Moreover, the display 48 has a known configuration in which, for example, sub-pixels of red (R), green (G), and blue (B) colors are arranged as a single pixel in a matrix-like manner. In this case, a single pixel is made of RGB sub-pixels arranged in the first direction. Moreover, an image that is displayed on a group of pixels, which are adjacent pixels equal in number to the number of parallaxes and which are arranged in the second direction that intersects with the first direction, is called an element image. Meanwhile, any other known arrangement of sub-pixels can also be adopted in the display 48. Moreover, the sub-pixels are not limited to the three colors of red (R), green (G), and blue (B). Alternatively, for example, the sub-pixels can also have four colors.

As far as the display 48 is concerned, it is possible to use a direct-view-type two-dimensional display such as an organic electro luminescence (organic EL), a liquid crystal display (LCD), a plasma display panel (PDP), a projection-type display, or a plasma display.

Regarding the optical element 46, the refractive-index distribution thereof changes according to the voltage applied thereto. The light beams that diverge from the display 48 toward the optical element 46 penetrate through the optical element 46, and are thus guided in the direction corresponding to the refractive-index distribution of the optical element 46.

As long as the refractive-index distribution of the optical element 46 changes according to the voltage applied thereto, any type of element can be used as the optical element 46. For example, a liquid crystal element in which a liquid crystal is dispersed between a pair of substrates can be used as the optical element 46.

In the embodiment, the explanation is given for an example in which a liquid crystal element is used as the optical element 46. However, the optical element 46 is not limited to a liquid crystal element. That is, as long as the refractive-index distribution of the optical element 46 changes according to the voltage applied thereto, it serves the purpose. Thus, for example, a liquid lens configured with two types of liquids such as an aqueous solution and oil can be used as the optical element 46, or a water lens that makes use of the surface tension of water can be used as the optical element 46.

The configuration of the optical element 46 is such that a liquid crystal layer 46C is placed in between a pair of substrates 46E and 46D. Moreover, the substrate 46E is equipped with an electrode 46A, while the substrate 46D is equipped with an electrode 46B. In the embodiment, the explanation is given for a configuration in which the substrate 46E is equipped with an electrode (the electrode 46A) as well as the substrate 46D is equipped with an electrode (the electrode 46B). However, as long as the configuration of the optical element 46 is such that a voltage can be applied to the liquid crystal layer 46C, the configuration explained above is not the only possible case. Alternatively, for example, the configuration can be such that only one of the substrates 46D and 46E is equipped with an electrode.

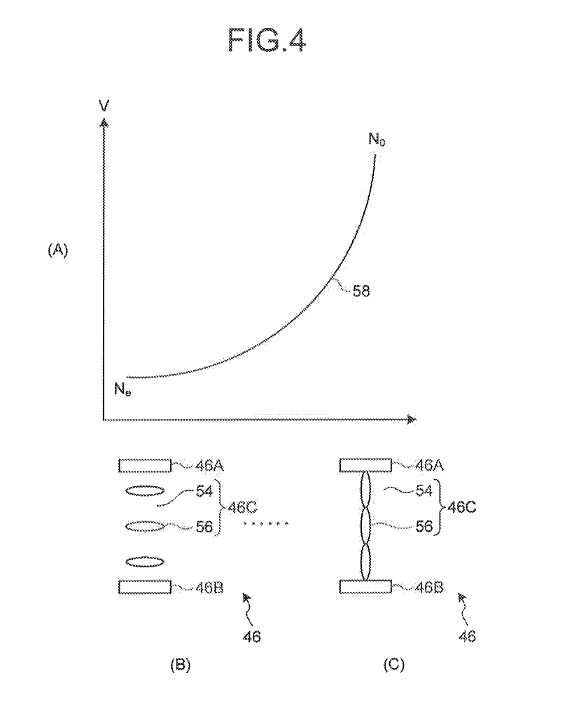

FIG. 3 is a schematic diagram illustrating a portion of the optical element 46 in an enlarged manner. As illustrated in FIG. 3, the liquid crystal layer 46C has a liquid crystal 56 dispersed in a dispersion medium 54. Herein, a liquid crystal material that indicates orientation according to the voltage applied thereto is used as the liquid crystal 56. As long as the liquid crystal material has that feature, any type of liquid crystal material can be used. For example, a nematic liquid crystal that undergoes a change in the orientation according to the voltage applied thereto can be used as the liquid crystal material. As a known fact, the liquid crystal material has an elongate shape and exhibits refractive index anisotropy in the longitudinal direction of its molecules. The intensity of voltage and the time period of applying that voltage with the aim of causing an orientational change in the liquid crystal 56 differs according to the type of the liquid crystal 56 or the according to configuration of the optical element 46 (i.e., according to the shapes and the placement of the electrode 46A and the electrode 46B).

For that reason, for example, a voltage is applied to the electrode 46A and the electrode 46B (for example, electrodes 46B₁ to 46B₃) in such a way that an electric field of a particular shape is formed at the position corresponding to each element pixel of the display 48. As a result, in the liquid crystal layer 46C, the liquid crystal 56 gets arranged in the orientation along the electric field, and the optical element 46 exhibits a refractive-index distribution corresponding to the applied voltage. That is because of the fact that the liquid crystal 56 exhibits refractive index anisotropy depending on the polarization state. More specifically, that is because, depending on the orientational change occurring due to the applied voltage, the liquid crystal 56 exhibits a change in the refractive index in an arbitrary polarization state.

For example, the electrode 46A and the electrode 46B are positioned in advance in such a way that a different electric field is formed at each position corresponding to each element pixel of the display 48. Then, a voltage is applied to the electrode 46A and the electrode 46B in such a way that an electric field of the shape of a lens 50 is formed in each area in the liquid crystal layer 46C that corresponds to an element pixel. As a result, the liquid crystal 56 present in the liquid crystal layer 46C exhibits the orientation along the electric fields formed according to the applied voltage. In this case, as illustrated in FIG. 3, the optical element 46 exhibits a refractive-index distribution of the shape of the lens 50. For that reason, in this case, as illustrated in FIG. 2, a refractive-index distribution is exhibited in the shape of a lens array that is made of a plurality of lenses 50 arranged in a predetermined direction.

This refractive-index distribution of the shape of a lens array is, for example, a refractive-index distribution along the direction of arrangement of the element pixels of the display 48. More particularly, for example, the optical element 46 exhibits a refractive-index distribution of the shape of a lens array either in the horizontal direction in the display surface of the display 48, or in the vertical direction in the display surface of the display 48, or in both the horizontal and vertical directions in the display surface of the display 48. Herein, whether or not to have a configuration in which the refractive-index distribution is indicated in either the horizontal direction, or the vertical direction, or both the horizontal and vertical directions can be adjusted depending on the configuration of the optical element 46 (that is, depending on the shapes and the placement of the electrode 46A and the electrode 46B).

Meanwhile, voltage conditions, such as the intensity of the voltage and the time period of applying that voltage, set for the purpose of having a particular orientation of the liquid crystal 56 differ according to the type of the liquid crystal 56 or according to the shapes and the placement of the electrode 46A and the electrode 46B.

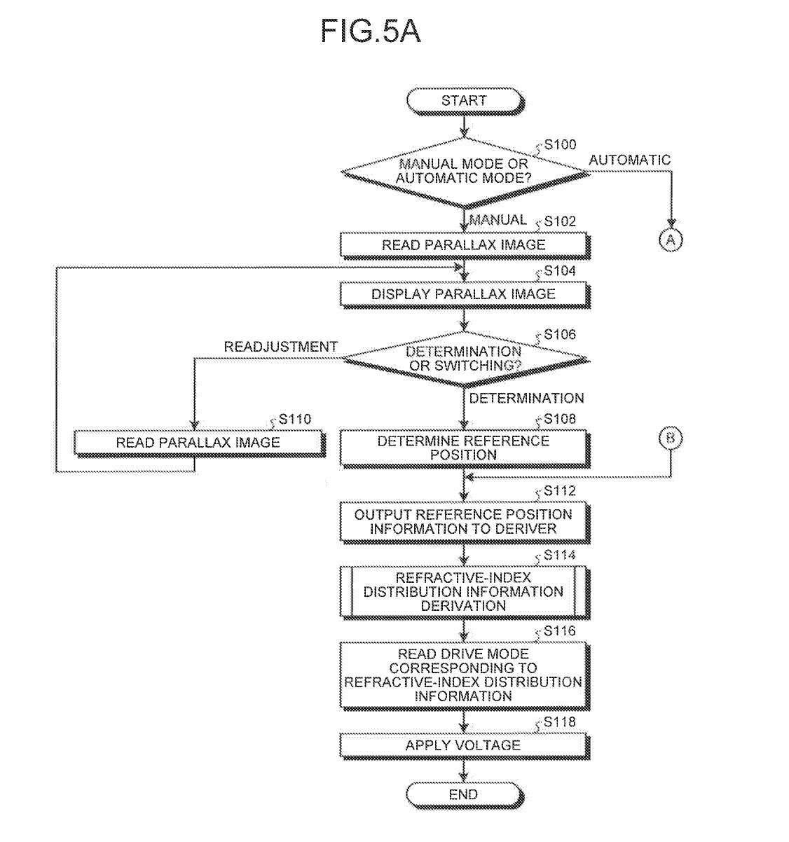

FIG. 4 is a diagram illustrating an example of the changes in the refractive index of the optical element 46 and the orientation state of the liquid crystal 56. More specifically, section (A) in FIG. 4 is a diagram illustrating an example of the relationship between the voltage applied to the electrode 46A and the electrode 46B and the refractive index of the optical element 46. Moreover, sections (B) and (C) in FIG. 4 are diagrams illustrating exemplary orientation states of the liquid crystal 56 corresponding to the refractive indices of the optical element 46.

In the example illustrated in FIG. 4, in the state in which no voltage is applied between the electrode 46A and the electrode 46B, the liquid crystal 56 is oriented in the horizontal direction (see section (B) in FIG. 4), and a refractive index n indicates a low value (see section (A) in FIG. 4). Then, the greater is the voltage value applied to the electrode 46A and the electrode 46B, the more the liquid crystal 56 gets oriented toward the vertical direction (see section (C) in FIG. 4). Accompanying such orientational changes, the refractive index n of the optical element 46 goes on increasing (see section (A) in FIG. 4). For that reason, in the example illustrated in FIG. 4, the relationship between the applied voltage and the refractive index of the optical element 46 is illustrated by a graph 58.

Thus, by adjusting the placement of the electrode 46A and the electrode 46B and by adjusting the conditions for applying voltage to the liquid crystal layer 46C via the electrode 46A and the electrode 46B, the optical element 46 exhibits a refractive-index distribution of the shape of the lens 50 as illustrated in FIG. 3. Accordingly, the optical element 46 exhibits a refractive-index distribution of the shape of a lens array as illustrated in FIG. 2.

In the embodiment, the explanation is given for an example in which the optical element 46 exhibits a refractive-index distribution of the shape of the lens 50 due to the application of voltage. However, the refractive-index distribution is not limited to be of the shape of the lens 50. Alternatively, for example, the optical element 46 can be configured to exhibit the refractive-index distribution of a desired shape depending on the drive mode to the electrode 46A and the electrode 46B or depending on the placement and the shapes of the electrode 46A and the electrode 46B. For example, the drive mode or the placement and the shapes of the electrode 46A and the electrode 46B can be adjusted in such a way that the optical element 46 exhibits a refractive-index distribution of a prism-like shape. Still alternatively, the drive mode can be adjusted in such a way that the optical element 46 exhibits a refractive-index distribution of a mixture of a prism-like shape and a lens-like shape.

The UI 16 is used by a user to perform various operation inputs. For example, the UI 16 is configured with a device such as a keyboard or a mouse. In the embodiment, the UI 16 is operated and instructed by the user at the time of inputting mode information, inputting a switching signal, or inputting a determination signal.

Herein, the switching signal is a signal representing a switch instruction for switching the image displayed on the display unit 14. The determination signal is a signal that indicates the determination of the image displayed on the display unit 14.

The mode information is the information containing whether the mode is a manual mode or an automatic mode. The manual mode indicates that a reference position, which represents a temporary position of the viewer, is determined to be at the desired position of the user. The automatic mode indicates that the reference position is determined as a result of a display process (described later) performed in the stereoscopic image display device 10.

The reference position represents a temporary position of the viewer in the real space. Moreover, the reference position indicates only a single position and not a plurality of positions. Furthermore, the reference position is represented by, for example, the coordinate information in the real space. For example, in the real space, with the center of the display surface of the display unit 14 serving as the origin; the horizontal direction is set to be the X-axis, the vertical direction is set to be the Y-axis, and the normal direction of the display surface of the display unit 14 is set to be the Z-axis. However, the method of setting the coordinates in the real space is not limited to this case.

The UI 16 receives the mode information, or the switching signal, or the determination signal as a result of a user operation; and outputs the received information to the controller 12.

The detector 18 detects a viewpoint position of the viewer, which is the actual position of the viewer present in the real space. In an identical manner to the reference position, the viewpoint position is also represented by the coordinate information in the real space. However, the viewpoint position is not limited to a single position.

As long as the viewpoint position represents the position of the viewer, it serves the purpose. More particularly, examples of the viewpoint position include the positions of the eyes of the viewer (with each eye having a position), the intermediate position between the two eyes, the position of the head, or the position of a predetermined body part of the body. The following explanation is given for an example in which the viewpoint position indicates the positions of the eyes of the viewer.

As long as the detector 18 is capable of detecting the viewpoint position, any known device can be used as the detector 18. For example, an imaging device such as a visible camera or an infrared camera, a radar, a gravitational acceleration sensor, or a distance sensor using infrared light can be used as the detector 18. Moreover, a combination of such devices can also be used as the detector 18. In such devices, the viewpoint position is detected from the obtained information (in the case of a camera, from a captured image) using a known technology.

For example, when a visible camera is used as the detector 18, it performs image analysis with respect to the images obtained by means of image capturing, and detects the viewer and calculates the viewpoint position of the viewer. With that, the detector 18 detects the viewpoint position of the viewer. Alternatively, when a radar is used as the detector 18, it performs signal processing with respect to the radar signals that are obtained, and detects the viewer and calculates the viewpoint position of the viewer. With that, the detector 18 detects the viewpoint position of the viewer.

In the detector 18, it is possible to store in advance the information that indicates whether the positions of the eyes of the viewer, or the intermediate position between the two eyes, or the position of the head, or the position of a predetermined body part of the body is to be calculated as the viewpoint position; and to store in advance the information containing the features of those positions. Such information can be referred to at the time of calculating the viewpoint position.

Meanwhile, as far as treating a predetermined body part of the body as the viewpoint position is concerned, the detector 18 can detect a predetermined body part such as the face of the viewer, the head of the viewer, the entire body of the viewer, or a marker that enables identification of the fact that a person is detected. Herein, a known technique can be implemented in order to detect a body part.

The detector 18 outputs, to the controller 12, viewpoint position information that indicates one or more viewpoint positions obtained as the detection result.

The controller 12 controls the stereoscopic image display device 10 in entirety, and is a computer that includes arbitrary processors such as a central processing unit (CPU), a read only memory (RO), and a random access memory (RAM).

In the embodiment, the controller 12 includes functional components in the form of an acquirer 20, a deriver 22, a storage unit 28, an applier 24, and a display controller 26. Herein, the explanation is given for an example in which these functional components as well as functional components (described later) included in these functional components are implemented when the CPU of the controller 12 loads various computer programs, which are stored in the ROM, in the PAM and runs them. However, alternatively, at least some of these functions can be implemented using individual circuits (hardware).

The acquirer 20 acquires the reference position. Besides, the acquirer 20 includes a first receiver 30, a storage unit 34, a switcher 36, a second receiver 32, a first calculator 40, a second calculator 42, and a determiner 44.

The first receiver 30 receives the mode information, the switching signal, and the determination signal from the UI 16. When the mode information indicates the manual mode, the first receiver 30 outputs the mode information and the switching signal to the switcher 36. On the other hand, when the mode information indicates the automatic mode, the first receiver 30 outputs the mode information to the first calculator 40. Moreover, the first receiver 30 outputs the received determination signal to the determiner 44.

The storage unit 34 is used to store the viewpoint position information, which contains a plurality of viewpoint positions in the real space, and the parallax images in a preliminarily corresponding manner. The parallax images corresponding to each set of viewpoint position information point to the parallax images at the time when the viewpoint position indicated by each set of viewpoint position information is present within a visible area within which stereoscopic images are stereoscopically viewable in a normal way.

Thus, the visible area points to such an area in the real space within which a display object that is displayed on the display 48 is stereoscopically viewable in a normal way. More particularly, for example, in the case when the optical element 46 exhibits a refractive-index distribution of the shape of a lens array, the visible area points to such an area in the real space within which fall the light beams from all lenses of the optical element 46.

Meanwhile, the storage unit 34 is also used to store in advance the information about a visible area angle 2θ of the display unit 14. Herein, the visible area angle points to an angle at which the viewer is able to view stereoscopic images displayed on the display unit 14, and represents the angle formed when the surface of the optical element 46 positioned on the side of the viewer is treated as the reference surface. In the embodiment, the area within the visible area angle is referred to as a setup visible area.

The visible area angle and the setup visible area are determined according to the number of parallaxes of the display 48 and according to the relative relationship between the pixels of the optical element 46 and the display 48. In the case when the optical element 46 exhibits a refractive-index distribution of the shape of a lens array in which areas exhibiting the refractive-index distribution of the lens 50 are arranged, the visible area angle 2θ is represented using Equation (1) given below.

2θ=arctan(P_{L}/g) (1)

In Equation (1), 2θ represents the visible area angle, P_{L} represents the pitch of the lens, and g represents the shortest distance between the optical element 46 and the display surface of the display 48.

The switcher 36 receives, from the first receiver 30, the mode information containing the manual mode and the switching signal. Every time the switching signal is received, the switcher 36 sequentially reads, from among a plurality of parallax images stored in the storage unit 34, a parallax image that is different than the parallax image displayed the previous time on the display 48; and outputs the parallax image that is read to the display controller 26 (described later). Then, the display controller 26 displays the parallax image on the display 48.

The second receiver 32 receives, from the detector 16, the viewpoint position information that contains one or more viewpoint positions. Then, the second receiver 32 outputs the viewpoint position information to the first calculator 40.

The first calculator 40 receives, from the acquirer 20, the mode information containing the automatic mode as well as receives, from the detector 18, the viewpoint position information containing one or more viewpoint positions. Then, based on the viewpoint position information that indicates one or more viewpoint positions and that is received from the detector 18, the first calculator 40 calculates the number of viewpoint positions. Subsequently, the first calculator 40 outputs, to the second calculator 42, the calculated number of viewpoint positions and the viewpoint position information containing the viewpoint positions.

The second calculator 42 receives, from the first calculator 40, the information about the number of viewpoint positions and the viewpoint position information (i.e., the coordinate information) containing the viewpoint positions. Then, with the surface of the optical element 46 positioned on the side of the viewer serving as the reference surface, the second calculator 42 moves the direction of the setup visible area, which is determined according to the visible area angle 2θ stored in the storage unit 34, by 180°. Moreover, the second calculator 42 determines whether or not all of the visible positions received from the first calculator 40 are present within the setup visible area. Based on the determination result, the second calculator 42 calculates the viewpoint positions that, from among the viewpoint positions received from the first calculator 40, are to be used in calculating the reference position (details described later). Then, the second calculator 42 calculates the gravity point of all viewpoint positions present within the setup visible area. More specifically, from the coordinate information of each viewpoint position, the second calculator 42 calculates the coordinate information of the center of gravity of each viewpoint position as the gravity point. The calculation of the gravity point can be done by implementing a known calculation method.

Upon receiving the mode information containing the manual mode from the first receiver 30, when the determination signal is received from the first receiver 30; the determiner 44 reads, from the storage unit 34, the viewpoint position specified in the viewpoint position information that corresponds to the parallax image displayed on the display 48 at the time of receiving the determination signal. Then, the determiner 44 determines the read viewpoint position to be the reference position. Moreover, upon receiving the mode information containing the automatic mode from the first receiver 30, the determiner 44 receives the gravity point from the second calculator 42. In that case the determiner 44 determines the gravity point to be the reference position (details described later). Then, the determiner 44 outputs, to the deriver 22, reference position information that indicates the single reference position that has been determined.

The deriver 22 derives the drive mode according to the reference position. Herein, the drive mode includes the voltage value and the voltage application time period of the voltage to be applied to the electrodes (the electrode 46A and the electrode 46B) of the optical element 46.

First, the deriver 22 calculates a first refractive-index distribution of the optical element 46 in such a way that the visible area, within which the display object displayed on the display unit 14 is stereoscopically viewable in a normal way, is set at the reference position specified in the reference position information received from the determiner 44 (details described later). Then, the deriver 22 derives a condition for applying a voltage in order to achieve the refractive-index distribution on the optical element 46.

The following explanation is given for an example in which the deriver 22 calculates refractive-index distribution information, which contains the first refractive-index distribution, according to the reference position. However, the method by which the deriver 22 derives the refractive-index distribution information is not limited to calculation. Alternatively, for example, the refractive-index distribution information containing the first refractive-index distribution can be stored in advance in a storage unit (not illustrated) in a corresponding manner to the reference position information containing the reference position. In that case, the deriver 22 can derive the first refractive-index distribution by reading, from that storage unit, the refractive-index distribution information containing the first refractive-index distribution that corresponds to the reference position received from the determiner 44.

The storage unit 28 is used to store in advance the refractive-index distribution information, which contains the refractive-index distribution derived by the deriver 22, in a corresponding manner to the drive mode. In the embodiment, the storage unit 28 is used to store, in a preliminarily corresponding manner, the condition for applying a voltage in order to achieve the refractive-index distribution, which is derived by the deriver 22, on the optical element 46.

The applier 24 applies a voltage in accordance with the drive mode, which are derived by the deriver 22, to the electrode 46A and the electrode 46B of the optical element 46.

The display controller 26 displays parallax images on the display 48.

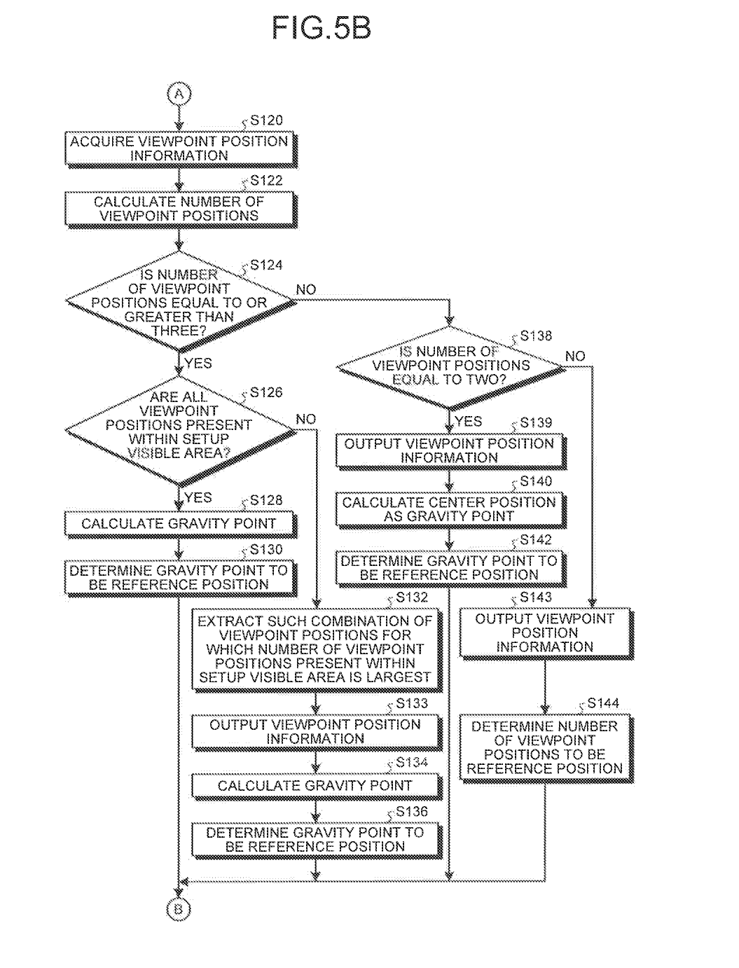

Given below is the explanation of the display process performed in the stereoscopic image display device 10 configured in the abovementioned manner according to the embodiment. FIG. 5 is a flowchart for explaining a sequence of processes performed during the display process performed in the stereoscopic image display device 10 according to the embodiment.

Firstly, the first receiver 30 determines whether the mode information received from the UI 16 indicates the manual mode or the automatic mode (Step S100).

If the mode information received from the UI 16 indicates the manual mode (manual at Step S100), then the switcher 36 selects a single parallax image from among a plurality of parallax images stored in the storage unit 34, and reads that parallax image (Step S102). Then, the display controller 26 displays that parallax image on the display 48 (Step S104).

Subsequently, the acquirer 20 determines whether a determination signal or a switching signal is received from the first receiver 30 (Step S106). If it is determined that a switching signal is received (readjustment at Step S106), then the acquirer 20 reads from the storage unit 34 a parallax image that is different than the previously-displayed parallax image (Step S110). Then, the system control returns to Step S104. On the other hand, if it is determined that a determination signal is received (determination at Step S106), then the determiner 44 reads from the storage unit 34 the parallax position information corresponding to the parallax image displayed on the display 48 at Step S104. Then, the acquirer 20 determines the parallax position information to be the reference position (Step S108).

Subsequently, the determiner 44 outputs, to the deriver 22, the reference position information that contains the reference position determined at Step S108 (Step S112). Then, depending on the reference position received from the determiner 44, the deriver 22 performs a refractive-index distribution information derivation process for deriving the refractive-index distribution information containing the first refractive-index distribution (Step S114). Regarding the refractive-index distribution information derivation process performed at Step S114, the details are given later.

As a result of the process performed at Step S114, the deriver 22 derives the refractive-index distribution information that contains the first refractive-index distribution corresponding to the reference position, and outputs the refractive-index distribution information to the applier 24.

Subsequently, the applier 24 reads from the storage unit 28 the drive mode corresponding to the refractive-index distribution information received from the deriver 22 (Step S116). Then, according to the drive mode read at Step S116, the applier 24 applies a voltage to the electrode 46A and the electrode 46B of the optical element 46 (Step S118). That marks the end of the routine.

As a result of the process performed at Step S118, the electrode 46A and the electrode 46B of the optical element 46 are applied with a voltage in accordance with the drive mode corresponding to the refractive-index distribution that has been derived. Hence, the optical element 46 exhibits that refractive-index distribution.

Meanwhile, at Step S100, if it is determined that the mode information received from the UI 16 indicates the automatic mode (automatic at Step S100), then the system control proceeds to Step S120. Then, the second receiver 32 obtains the viewpoint position information from the detector 18 (Step S120).

Subsequently, the first calculator 40 obtains from the second receiver 32 the viewpoint position information that indicates one or more viewpoint positions detected by the detector 18 (Step S120). Then, the first calculator 40 calculates the number of viewpoint positions that is specified in the received viewpoint position information (Step S122). This calculation of the viewpoint positions is done by calculating the number of viewpoint positions (sets of coordinate information) specified in the viewpoint position information.

Then, the second calculator 42 determines whether or not the number of viewpoint positions calculated by the first calculator 40 is equal to or greater than three (Step S124). If the number of viewpoint positions is equal to or greater than three (Yes at Step S124), the system control proceeds to Step S126.

Subsequently, the second calculator 42 determines whether or not all of the viewpoint positions, which are specified in the viewpoint position information obtained from the first calculator 40, are present within the setup visible area (Step S126).

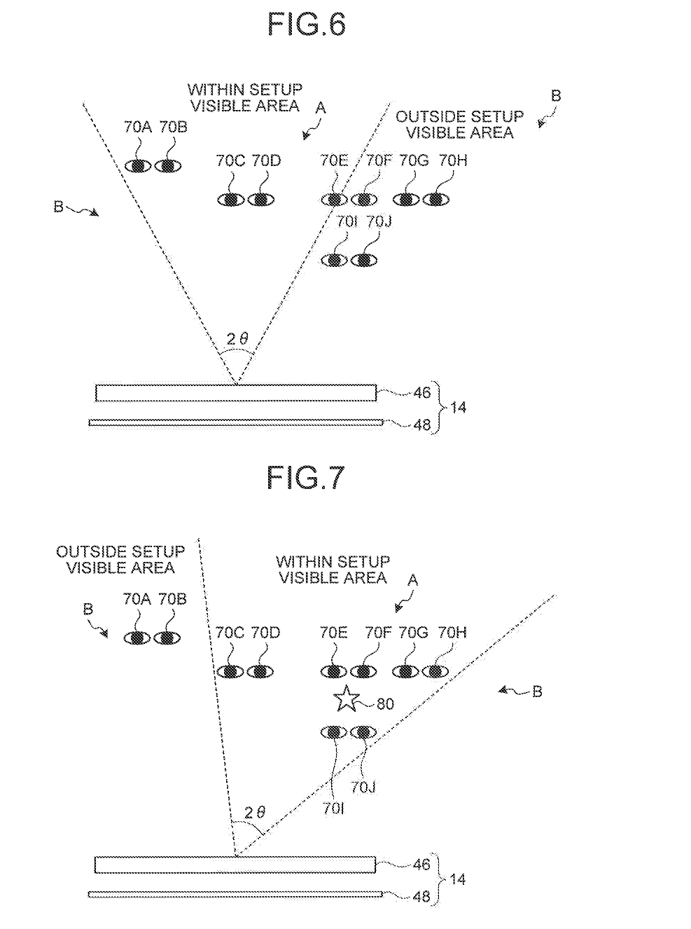

FIGS. 6 and 7 are schematic diagrams each illustrating an example of a plurality of viewpoint positions and the setup visible area. For example, assume that the detector 18 detects ten viewpoint positions, namely, a viewpoint position 70A to a viewpoint position 70J.

In this case, with the surface of the optical element 46 positioned on the side of the viewer serving as the reference surface, the second calculator 42 moves the direction of a setup visible area A, which is determined according to the visible area angle 2θ stored in the storage unit 34, by 180° (see FIGS. 6 and 7). Then, at Step S126, the second calculator 42 determines whether or not the direction of the setup visible area A is such that all of the viewpoint positions 70A to 70J, which are received from the first calculator 40, are present within the setup visible area A. Herein, FIGS. 6 and 7 are schematic diagrams illustrating cases in which some viewpoint positions from among the viewpoint positions 70A to 70J are not present within the setup visible area A.

In the case when the direction of the setup visible area A is such that all of the viewpoint positions 70A to 70J are present within the setup visible area A, the second calculator 42 determines that all of the viewpoint positions specified in the viewpoint position information obtained from the first calculator 40 are present within the setup visible area (Yes at Step S126) (see FIG. 5).

Then, the second calculator 42 calculates the gravity point of all viewpoint positions present within the setup visible area (Step S128). More specifically, from the coordinate information of each viewpoint position, the second calculator 42 calculates the coordinate information of the center of gravity of each viewpoint position as the gravity point. The calculation of the gravity point can be done by implementing a known calculation method.

Then, the determiner 44 determines the gravity point, which is calculated at Step S128, to be the reference position (Step S130). The system control then returns to Step S112.

Meanwhile, if the second calculator 42 determines that all viewpoint positions specified in the viewpoint position information are not present within the setup visible area (No at Step S126), that is, if, for example, the direction of the setup visible area A is such that all of the viewpoint positions 70A to 70J are not present within the setup visible area A; then the system control proceeds to Step S132.

Then, from among the three or more viewpoint positions received from the first calculator 40, the second calculator 42 extracts such a combination of the viewpoint positions for which the number of viewpoint positions present within the setup visible area A is the largest (Step S132).

Subsequently, the second calculator 42 outputs to the determiner 44 the viewpoint position information containing the extracted viewpoint positions (Step S133).

Then, in an identical manner to Step S128, the determiner 44 calculates the gravity point of a plurality of viewpoint positions extracted as the combination of viewpoint positions for which the number of viewpoint positions present within the setup visible area A is the largest (Step S134). Subsequently, the determiner 44 determines the gravity point, which is calculated at Step S134, to be the reference position (Step S136). The system control then returns to Step S112.

As far as the process performed at Step S132 is concerned, for example, in the example illustrated in FIG. 7, the second calculator 42 extracts the viewpoint positions 70C to 70J as the combination of viewpoint positions for which the number of viewpoint positions present within the setup visible area A is the largest. Then, at Step S134, as the gravity point of the viewpoint positions 70C to 70J, the determiner 44 calculates, for example, the position coordinates of a gravity point 80 illustrated in FIG. 7.

Meanwhile, if it is determined at Step S124 that the number of viewpoint positions calculated by the first calculator 40 is smaller than three (No at Step S124), then the system control proceeds to Step S138. Then, at Step S138, the second calculator 42 determines whether or not the number of viewpoint positions calculated by the first calculator 40 is equal to two (Step S138).

If the number of viewpoint positions calculated by the first calculator 40 is equal to two (Yes at Step S138), then the system control proceeds to Step S139. Subsequently, the second calculator 42 outputs to the determiner 44 the viewpoint position information that contains the two viewpoint positions obtained from the first calculator 40 (Step S139).

Then, the determiner 44 calculates the center position of the two viewpoint positions, which are received from the second calculator 42, as the gravity point (Step S140). The calculation of the gravity point at Step S140 can be done by implementing a known calculation method.

Subsequently, the determiner 44 determines the gravity point, which is calculated at Step S140, to be the reference position (Step S142). Then, the system control returns to Step S112.

Meanwhile, if the number of viewpoint positions calculated by the first calculator 40 is equal to one (No at Step S138), then the system control proceeds to Step S143. Subsequently, the second calculator 42 outputs to the determiner 44 the viewpoint position information that indicates the one viewpoint position obtained from the first calculator 40 (Step S143).

Subsequently, the determiner 44 determines the one viewpoint position, which is received from the second calculator 42, to be the reference position (Step S144). Then, the system control returns to Step S112.

Given below is the detailed explanation of a refractive-index distribution derivation process (Step S114 in FIG. 5).

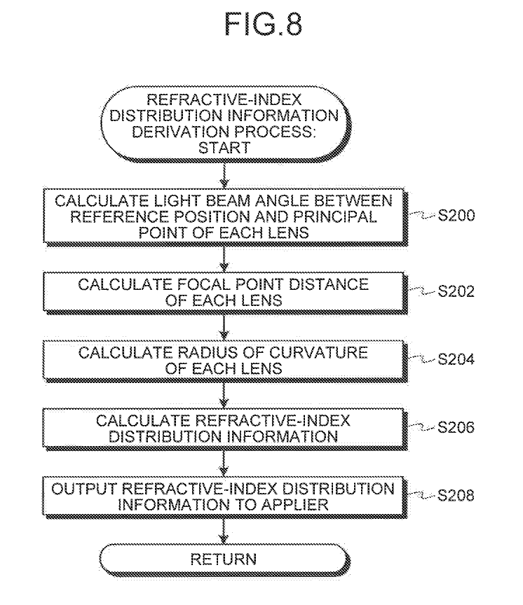

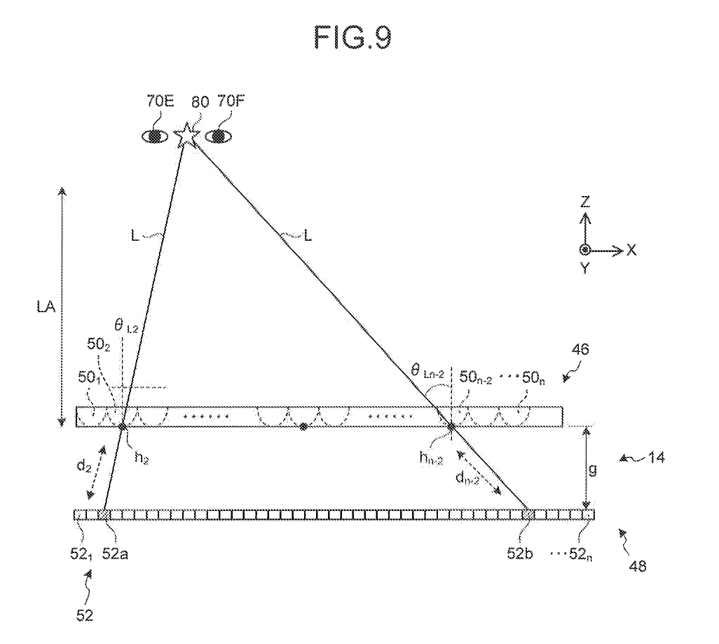

FIG. 8 is a flowchart for explaining a sequence of processes performed in the refractive-index distribution derivation process. FIG. 9 is a schematic diagram illustrating the positional relationship between the single reference position 80 and the display unit 14.

In FIG. 8 is illustrated an example of the refractive-index distribution derivation process in the case when the optical element 46 exhibits a refractive-index distribution of the shape of a lens array according to the voltage applied thereto. More specifically, the following explanation is given for an example in which, as illustrated in FIG. 9, a refractive-index distribution of the shape of a lens array having n number of lenses from a lens 50₁ to a lens 50ₙ is formed in the optical element 46 (where n is an integer equal to or greater than one) due to the application of voltage. In the case of collectively referring to the lenses 50₁ to 50ₙ that configure the lens array, they are referred to as lenses 50.

Firstly, the deriver 22 calculates a light beam angle θ_{L1} to a light beam angle θ_{Ln} that are angles between the single reference position 80, which is acquired from the acquirer 20, and a principal point h₀ to a principal point hₙ, respectively, of the lenses 50₁ to 50ₙ, respectively (Step S200). Herein, the light beam angle θ_{L1} to the light beam angle θ_{Ln} represent angles made by a straight line, which passes through the principal point h₀ to the principal point hₙ of the lenses 50₁ to 50ₙ, respectively, in the thickness direction of the optical element 46 (i.e., in the Z-axis direction that is perpendicular to the XY plane serving as the surface direction of the optical element 46), with light beams L joining the reference positions 80 with the principal point h₀ to the principal point hₙ of the lenses 50₁ to 50ₙ, respectively (i.e., represent angles in the aperture portion on the side of the viewer).

For example, in FIG. 9, θ_{L2} represents a light beam angle between the light beam L, which joins the principal point h₂ of the lens 50₂ with the reference position 80, and the straight line passing through the principal point h₂ in the Z-axis direction. In an identical manner, θ_{Ln-2} represents a light beam angle between the light beam L, which joins the principal point hₙ₋₂ of the lens 50ₙ₋₂ with the reference position 80, and the straight line passing through the principal point hₙ₋₂ in the Z-axis direction.

At Step S200, the deriver 22 calculates the light beam angle θ_{L1} to the light beam angle θ_{Ln} using Equation (2) given below.

θ_{Ln}=arctan(Xₙ/LA) (2)

In Equation (2), n represents an integer equal to or greater than one, and the light beam angle θ_{Ln} represents each of the light beam angle θ_{L1} to the light beam angle θ_{Ln}. Moreover, in Equation (2), Xₙ represents the horizontal distance from the reference position 80 to each of the principal point h₁ to the principal point hₙ.

Meanwhile, each principal point position has the X-coordinate in the integral multiple of the lens pitch, and is calculated according to the difference between the distance of the X-coordinate of the reference position 80.

Returning to the explanation with reference to FIG. 8, the deriver 22 then calculates a focal point distance d of each lens 50 (Step S202).

When a viewer sees the display unit 14 from the reference position 80, he or she sees the light emitted from the pixels 52 that, from among a plurality of pixels 52 present in the display 40, are positioned on the extended line of the straight line L which joins the reference position 80 with the principal points h₀ to hₙ of the lenses 50. Moreover, a distance d₁ to a distance dₘ, which are distances between the principal points h₀ to hₙ, respectively, of the lenses 50 and the pixels 52 positioned on the extended line of the straight line L which joins the reference position 80 with the principal points h₀ to hₙ of the lenses 50, differ according to the light beam angle θ_{L1} to the light beam angle θ_{Ln}. That is, the distances d₁ to dₘ differ according to the positional relationship of the positions of the lenses 50, which are indicated by the refractive index of the optical element 46, with the reference position 80.

In FIG. 9, as representative examples are illustrated the distance d₂, which is the distance from the principal point h₂ of the lens 50₂ to a pixel 52a that is positioned on the extended line of the straight line L joining the principal point h₂ of the lens 50₂ with the reference position 80, and the distance dₙ₋₂, which is the distance from the principal point hₙ₋₂ of the lens 50ₙ₋₂ to a pixel 52b that is positioned on the extended line of the straight line L joining the principal point hₙ₋₂ of the lens 50ₙ₋₂ with the reference position 80. Regarding the other lenses 50 too, the distance d is determined in an identical manner.

In the embodiment, in order to ensure that the focal point distance of each lens 50 is identical to the corresponding distance from among the distances d₁ to dₘ, the deriver 22 performs the processes explained below; determines the refractive index of each lens 50; and derives the refractive-index distribution information containing the first refractive-index distribution. With that, the deriver 22 derives the refractive-index distribution information, which contains the first refractive-index distribution in the surface direction of the optical element 46, according to the reference position in such a way that the visible area, within which the display object displayed in the display unit 14 is stereoscopically viewable in a normal way, is set at the reference position.

That is, firstly, the deriver 22 calculates each of the distances d₁ to dₘ corresponding to the lenses 50 as the focal point distance d of each lens 50 (Step S202).

Herein, the deriver 22 calculates the focal point distance d, that is, calculates each of the distances d₁ to dₘ corresponding to the lenses 50 using Equation (3) given below.

dₙ=g/cos θ_{Ln} (3)

In Equation (3), dₙ represents each of the distances d₁ to dₘ corresponding to the lenses 50. Moreover, in Equation (3), g represents the shortest distance between the optical element 46 and the display unit 14. Furthermore, in Equation (3), θ_{Ln} represents the light beam angle θ_{L1} to the light beam angle θ_{Ln}.

Then, the deriver 22 calculates the radius of curvature of each lens 50 (Step S204). Herein, the deriver 22 calculates the radius of curvature of each lens 50 in such a way that the focal point distance of each lens 50 is identical to the corresponding distance from among the distances d₁ to dₘ.

More particularly, the deriver 22 calculates the radius of curvature of each lens 50 using Equation (4) given below.

R²=dₙ×2t(Ne−No) (4)

In Equation (4), R represents the radius of curvature of each lens 50; dₙ represents the distance corresponding to each lens 50 from among the distances d₁ to dₘ; and t represents the thickness of each lens 50. Moreover, Ne represents the refractive index in the long axis direction of the liquid crystal 56 (see FIG. 3) in the optical element 46; and No represents the refractive index in the short axis direction of the liquid crystal 56 (see FIG. 3) in the optical element 46.

Returning to the explanation with reference to FIG. 8, subsequently, the deriver 22 calculates the refractive-index distribution information (Step S206).

At Step S206, the deriver 22 calculates the refractive-index distribution information containing the first refractive-index distribution, which represents the refractive index distribution of each lens 50, in such a way that, according to a radius of curvature R calculated for each lens 50 at Step S204, each lens 50 has the corresponding radius of curvature P calculated at Step S204.

More specifically, the deriver 22 calculates the refractive-index distribution information that satisfies the relationship given below in Equation (5).

Δn=cX_{L}²/(1+{square root over ((1−(k+1)c²X_{L}²)))} (5)

In Equation (5), Δn represents the refractive-index distribution of each lens 50. More specifically, Δn represents the refractive-index distribution within the lens pitch of each lens 50. Moreover, in Equation (5), c represents 1/R; and R represents the radius of curvature of each lens 50. Furthermore, X_{L} represents the horizontal distance within the pitch lens of each lens 50. Moreover, k represents a constant number, which is also referred to as an aspheric coefficient and is fine-tuned for the purpose of enhancing the light collecting characteristics of the lenses 50.

Then, the deriver 22 outputs to the applier 24 the refractive-index distribution information calculated at Step S206 (Step S208).

Upon receiving the refractive-index distribution information; as explained with reference to FIG. 5, the applier 24 reads from the storage unit 28 the drive mode corresponding to the refractive-index distribution information received from the deriver 22 (Step S116). Then, according to the drive mode read at Step S116, the applier 24 applies a voltage to the electrode 46A and the electrode 46B of the optical element 46 (Step S118). That marks the end of the routine.

As described above, in the stereoscopic image display device 10 according to the embodiment, a reference position is determined that indicates a temporary position of the viewer. Then, based on the reference position, the refractive-index distribution information containing the first refractive-index distribution of the optical element 46 is derived in such a way that the visible area, within which the display object displayed on the display unit 14 is stereoscopically viewable in a normal way, is set at the reference position. Then, to the optical element 46 is applied a voltage according to the drive mode corresponding to the refractive-index distribution information.

Hence, in the stereoscopic image display device 10 according to the embodiment, even if there is a change in the viewpoint position, it becomes possible to reduce the increase in the amount of crosstalk.

Meanwhile, in the embodiment, the explanation is given for an example in which the processes described above are performed; the refractive index of each lens 50 is determined; and the refractive-index distribution information containing the first refractive-index distribution is derived in order to ensure that the focal point distance of each lens 50 is identical to the corresponding distance from among the distances d₁ to dₘ. However, that is not the only possible method. That is, as long as the refractive-index distribution information containing the first refractive-index distribution in the surface direction of the optical element 46 is derived according to the reference position in such a way that the visible area, within which the display object displayed on the display unit 14 is stereoscopically viewable in a normal way, is set at the reference position; it serves the purpose. Moreover, the explanation is given for an example in which the focal point distance of each lens 50 is identical to the corresponding distance from among the distances d₁ to dₘ. However, with the aim of adding image effects to the image quality of the display unit 14, the focal point distance of each lens 50 can be different than the corresponding distance by an amount equal to the scope of adjustment.

Meanwhile, a display processing program that is executed in the controller 12 of the stereoscopic image display device 10 according to the embodiment for the purpose of performing the display process is stored in advance in a ROM or the like.

Alternatively, the display processing program that is executed in the controller 12 of the stereoscopic image display device 10 according to the embodiment can be recorded in the form of an installable or executable file in a computer-readable recording medium such as a compact disk read only memory (CD-ROM), a flexible disk (FD), a compact disk readable (CD-R), or a digital versatile disk (DVD); and can be provided as a computer program product.

Still alternatively, the display processing program that is executed in the controller 12 of the stereoscopic image display device 10 according to the embodiment can be saved as a downloadable file on a computer connected to the Internet or can be made available for distribution through a network such as the Internet.

Meanwhile, the display processing program that is executed in the controller 12 of the stereoscopic image display device 10 according to the embodiment contains a module for each of the abovementioned constituent elements (i.e., the acquirer 20 (the first receiver 30, the second receiver 32, the storage unit 34, the switcher 36, the first calculator 40, the second calculator 42, and the determiner 44), the deriver 22, the storage unit 28, the applier 24, and the display controller 26). As the actual hardware, a CPU (processor) reads the display processing program from a ROM and runs it such that the display processing program is loaded in a main storage device. As a result, the acquirer 20 (the first receiver 30, the second receiver 32, the storage unit 34, the switcher 36, the first calculator 40, the second calculator 42, and the determiner 44), the deriver 22, the storage unit 28, the applier 24, and the display controller 26 are generated in the main storage device.

Part or all of the functions of the abovementioned constituent elements (i.e., the acquirer 20 (the first receiver 30, the second receiver 32, the storage unit 34, the switcher 36, the first calculator 40, the second calculator 42, and the determiner 44), the deriver 22, the storage unit 28, the applier 24, and the display controller 26) may be realized by running a program or programs on one or more processors such as a CPU, which in other words may be realized by software. Alternatively, part or all of the functions of the abovementioned constituent elements may be realized by hardware such as a large scale integration (LSI) chip, a digital signal processor (DSP), a field programmable gate array (FPGA), and an integrated circuit (IC). Alternatively, part or all of the functions of the abovementioned constituent elements may be realized by both software and hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image display device, comprising:
a display having a display surface including pixels arranged thereon;
an optical element of which a refractive-index distribution changes according to an applied voltage;
a detector configured to detect a viewpoint position representing a position of a viewer;
a calculator configured to calculate a gravity point of the viewpoint positions when a plurality of viewpoint positions are detected,
a deriver configured to derive a drive mode according to the gravity point, the drive mode indicating a voltage to be applied to the optical element; and
an applier to apply a voltage to the optical element according to the drive mode such that a visible area within which a display object displayed on the display is stereoscopically viewable is set at the gravity position.

2. The device according to claim 1, wherein the optical element has a refractive-index distribution with a shape of an array of lenses, depending on the applied voltage.

3. The device according to claim 2, wherein the deriver is configured to calculate a radius of curvature of each lens in such a manner that a distance between each pixel and a principal point of the each lens of the optical element on an extended line of a light beam connecting the gravity position and the principal point serves as a focal point distance of the each lens, derive a first refractive-index distribution such that the each lens has the corresponding radius of curvature, and derive a condition for applying the voltage to have the first refractive-index distribution on the optical element.

4. The device according to claim 2, wherein the optical element is a liquid crystal element

5. The device according to claim 2, wherein the applied voltage is obtained such that focal point distances of the respective lenses are identical to each other.

6. The device according to claim 1, wherein the calculator is configured to calculate a combination of the viewpoint positions for which the number of detected viewpoint positions present within the setup visible area is the largest to calculate the gravity point of the viewpoint positions present in the calculated combination when some of the viewpoint positions are not preset within the setup visible area.

7. The device according to claim 1, further comprising:
a storage unit configured to store in advance the viewpoint position and a parallax image in which the viewpoint position is set within the visible area;
a display controller configured to display the parallax image on the display;
a receiver configured to receive a manual signal indicating a manual mode, a switching signal for switching the parallax image displayed on the display, and a determination signal for determining the parallax image being displayed; and
a switcher configured to switch the parallax image displayed on the display unit every time the switching signal is received, wherein
the calculator calculates a gravity point of the viewpoint positions that corresponds to the parallax image being displayed on the display when the determination signal is received after the manual signal is received.

8. A control device, comprising:
a detector configured to detect a viewpoint position representing a position of a viewer;
a calculator configured to calculate a gravity point of the viewpoint positions when a plurality of viewpoint positions are detected;
a deriver configured to derive a drive mode according to the gravity point, the drive mode indicating a voltage to be applied to an optical element of which a refractive-index distribution changes according to an applied voltage; and
an applier to apply a voltage to the optical element according to the drive mode such that a visible area within which a display object displayed on a display having a display surface including pixels arranged thereon is stereoscopically viewable is set at the gravity position.

9. The device according to claim 8, wherein the optical element has a refractive-index distribution with a shape of an array of lenses, depending on the applied voltage.

10. The device according to claim 9, wherein the deriver is configured to calculate a radius of curvature of each lens in such a manner that a distance between each pixel and a principal point of the each lens of the optical element on an extended line of a light beam connecting the gravity position and the principal point serves as a focal point distance of the each lens, derive a first refractive-index distribution such that the each lens has the corresponding radius of curvature, and derive a condition for applying the voltage to have the first refractive-index distribution on the optical element.

11. The display device according to claim 9, wherein the optical element is a liquid crystal element

12. The device according to claim 9, wherein the applied voltage is obtained such that focal point distances of the respective lenses are identical to each other.

13. The device according to claim 8, wherein the calculator is configured to calculate a combination of the viewpoint positions for which the number of detected viewpoint positions present within the setup visible area is the largest to calculate the gravity point of the viewpoint positions present in the calculated combination when some of the viewpoint positions are not preset within the setup visible area.

14. The device according to claim 8, further comprising:
a storage unit configured to store in advance the viewpoint position and a parallax image in which the viewpoint position is set within the visible area;
a display controller configured to display the parallax image on the display;
a receiver configured to receive a manual signal indicating a manual mode, a switching signal for switching the parallax image displayed on the display, and a determination signal for determining the parallax image being displayed; and
a switcher configured to switch the parallax image displayed on the display unit every time the switching signal is received, wherein
the calculator calculates a gravity point of the viewpoint positions that corresponds to the parallax image being displayed on the display when the determination signal is received after the manual signal is received.

15. A display processing method implemented in a stereoscopic image display device that includes a display having a display surface with pixels arranged thereon, and an optical element of which a refractive-index distribution changes according to an applied voltage, the method comprising:
detecting a viewpoint position representing a position of a viewer;
calculating a gravity point of the viewpoint positions when a plurality of viewpoint positions are detected;
deriving a drive mode according to the gravity point, the drive mode indicating a voltage to be applied to the optical element; and
applying a voltage to the optical element according to the drive mode such that a visible area within which a display object displayed on the display is stereoscopically viewable is set at the gravity position.

16. The method according to claim 15, wherein the optical element has a refractive-index distribution with a shape of an array of lenses, depending on the applied voltage.

17. The method according to claim 16, the deriving includes calculating a radius of curvature of each lens in such a manner that a distance between each pixel and a principal point of the each lens of the optical element on an extended line of a light beam connecting the gravity position and the principal point serves as a focal point distance of the each lens, deriving a first refractive-index distribution such that the each lens has the corresponding radius of curvature, and deriving a condition for applying the voltage to have the first refractive-index distribution on the optical element.

18. The method according to claim 16, wherein the optical element is a liquid crystal element.

19. The method according to claim 16, wherein the applied voltage is obtained such that focal point distances of the respective lenses are identical to each other.

20. The method according to claim 15, wherein the calculating includes calculating a combination of the viewpoint positions for which the number of detected viewpoint positions present within the setup visible area is the largest to calculate the gravity point of the viewpoint positions present in the calculated combination when some of the viewpoint positions are not preset within the setup visible area.
